(19) United States
(12) Patent Application Publication
(10) Pub. No.: US 2017/0046337 A1
(43) Pub. Date: Feb. 16, 2017

(54) LANGUAGE INTERPRETATION/TRANSLATION RESOURCE CONFIGURATION

(71) Applicant: Language Line Services, Inc., Monterey, CA (US)

(72) Inventors: Jeffrey Cordell, Carmel, CA (US); James Boutcher, Carmel, CA (US)

(73) Assignee: LANGUAGE LINE SERVICES, INC., Monterey, CA (US)

(21) Appl. No.: 14/826,060

(22) Filed: Aug. 13, 2015

(51) Int. Cl. G06F 17/28

(52) U.S. Cl. CPC G06F 17/2881

(57) ABSTRACT

A computer implemented language interpretation/translation platform is provided. The computer implemented language interpretation/translation platform comprises a receiver that receives, via an Application Programming Interface, a request for a language interpretation/translation resource from a communication device. The request includes a preferred communication channel. Further, the computer implemented language interpretation/translation platform comprises a processor that determines, via the Application Programming Interface, availability of the language interpretation/translation resource, allocates the language interpretation/translation resource to perform the request, and connects the communication device to the language interpretation/translation resource according to the preferred communication channel.

### BACKGROUND

1. Field

This disclosure generally relates to the field of language interpretation/translation. More particularly, the disclosure relates to computer implemented language interpretation/translation platforms that provide language interpretation/translation services.

2. General Background

Current language interpretation/translation service providers provide the ability for customers to interact with a language interpreter or a translator. Such language interpretation/translation services are often helpful in a variety of contexts, e.g., medical, business, etc. For instance, such language interpretation/translation services allow a person with limited English proficiency (“LEP”) to communicate effectively with an English speaking person via a language interpreter.

Such language interpretation/translation service providers are having more difficulty providing language interpretation/translation services for a variety of reasons. With advances in business globalization and ecommerce, demand has increased for language interpretation/translation for more languages, e.g., hundreds of languages. Staffing language interpreters/translators for such a substantial amount of languages is often difficult and expensive.

Further, customers of language interpretation/translation service providers have expressed more of a need for particular attributes for the language interpreter/translators. For instance, such attributes include medical training, certified emergency response call processing, gender preference, domestic or foreign, etc.

In addition, advances in technology have led to an increase in requests from customers of language interpretation/translation service providers for language interpretation/translation services across a variety of different channels and modalities of communication, e.g., face to face, over the phone, SMS texting, video, mobile application, written words, short pre-recorded voice message for transcription, translation, etc. The language interpretation/translation service providers may also have to provide solutions for emerging technologies.

Further, current language interpretation/translation providers often utilize an interactive voice response (“IVR”) system that automatically interacts with customers through voice and DTMF tones via keypad or keyboard inputs. Customers often have to provide customer information, e.g., customer identifiers, PINs, language selections, etc. to such systems prior to obtaining access to language interpretation/translation resources. Such interactions are often considered by many customers to be too time consuming and repetitive as each IVR interaction often asks for similar customer information. Further, customers often have to remember such identifying information. Therefore, utilization of the IVR system to obtain language interpretation/translation services is often a cumbersome process for users.

Thus, current language interpretation/translation providers often have difficulty providing language interpretation/translation services that meet such varied customer language and technology requests in a manner in which user access is not cumbersome. As a result, users may not receive an optimal level of language interpretation/translation.

### SUMMARY

A computer implemented language interpretation/translation platform is provided. The computer implemented language interpretation/translation platform comprises a receiver that receives, via an Application Programming Interface, a request for a language interpretation/translation resource from a communication device. The request includes a preferred communication channel. Further, the computer implemented language interpretation/translation platform comprises a processor that determines, via the Application Programming Interface, availability of the language interpretation/translation resource, allocates the language interpretation/translation resource to perform the request, and connects the communication device to the language interpretation/translation resource according to the preferred communication channel.

A computer program product is also provided. The computer program product comprises a non-transitory computer readable storage device having a computer readable program stored thereon. When executed on a computer, the computer readable program causes the computer to receive, with a receiver via an Application Programming Interface, a request for a language interpretation/translation resource from a communication device. The request includes a preferred communication channel. Further, the computer is caused to determine, with a processor via the Application Programming Interface, availability of the language interpretation/translation resource. In addition, the computer is caused to allocate, with the processor via the Application Programming Interface the language interpretation/translation resource to perform the request. The computer is also caused to connect, with the processor via the Application Programming Interface, the communication device to the language interpretation/translation resource according to the preferred communication channel.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a language interpretation/translation configuration.

FIG. 2 illustrates a language interpretation/translation resource configuration.

FIG. 3 illustrates the internal components of the language resource engine illustrated in FIG. 2.

FIG. 4 illustrates a process that may be utilized to perform language interpretation/translation resource allocation.

### DETAILED DESCRIPTION

A computer implemented language interpretation/translation resource system, which shall be referred to as a language interpretation/translation resource system, provides an efficient real-time ability for a customer of a language interpretation/translation service provider to inquire about available language interpreter/translator resources across a set of such resources. The resources may include a variety of products and/or services that provide or help facilitate language interpretation/translation.

The language interpretation/translation resource system also allows the customer to reserve and access a language interpretation/translation service according to a preferred customer communication channel. For example, a customer that prefers to obtain a language interpretation/translation service via video conferencing is able to determine which language interpreters are available for such a language interpretation service at a time that is workable for the customer.

The computer implemented language interpretation/translation resource system provides a marketplace where language interpreters/translators may register and provide their language interpretation/translation services to customers of language interpretation service providers or other users that are in need of language interpretation/translation services. Further, businesses and resellers of language interpretation/translation services may access corresponding language interpretation/translation services on-demand or generate a reservation for subsequent language interpretation/translation interaction.

Further, the computer implemented language interpretation/translation resource system may be utilized to negotiate the terms of the particular language interpretation/translation service. For example, the computer implemented language interpretation/translation resource system may negotiate interpreter fee rates, payment terms, and service details.

The language interpretation/translation resource system improves the functionality of a computer by bypassing the need for an IVR. The language interpretation/translation resource system may automatically interact with an application stored on a computing device that is utilized by a user, e.g., a personal computer, a laptop computer, a tablet device, a smartphone, etc. to obtain customer identifying information without utilization of an IVR. For example, the automatic number identification (“ANI”), which determines the originating telephone number from which a communication is placed, and a Dialed Number Identification Service (“DNIS”), which is a code for the telephone number requested by the caller, may be obtained via the language interpretation/translation resource system via the language interpretation/translation resource system. The language interpretation/translation resource system may obtain the customer information and/or other information without the customer having to interact with an IVR to manually provide such information.

Further, the language interpretation/translation resource system improves the functionality of a computer by allowing interaction with the application on the computing device to determine optimal modes of communication for the particular computing device. For example, a particular computing device may be capable of effectively providing a high quality voice based language interpretation/translation service, but only a low quality video conference based language interpretation/translation service. The language interpretation/translation resource system may interact with the application to determine and/or recommend a channel of communication for the language interpretation/translation service so that the language interpretation/translation resource system may provide the customer with a high quality language interpretation/translation service.

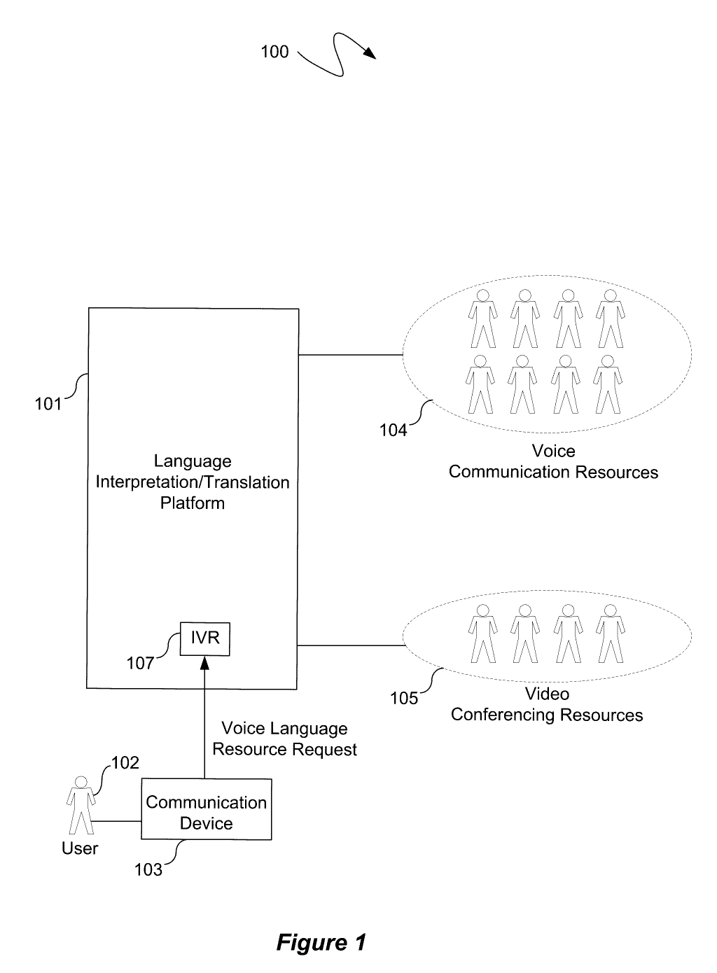

FIG. 1 illustrates a language interpretation/translation configuration 100. The language interpretation/translation configuration 100 includes a language interpretation/translation platform 101 that is based upon utilization of an IVR 107. In other words, a user 102 provides various information to the language interpretation/translation platform 101 via the IVR 107. The user 102 can send requests for various language/interpretation resources that may be utilized for language/interpretations services. For example, voice communication resources 104 may include language interpreters/translators and/or associated devices that provide voice based language interpretation/translation services. Further, video conferencing resources 105 may include language interpreters/translators and/or associated devices that provide video conferencing based language interpretation/translation services.

The language interpretation/translation configuration 100 is a static configuration that does not allow for resources to be redistributed from one set to another set. For example, the language interpreters/translators in the voice communication resources 104 are designated for a particular rate whereas the language interpreters/translators in the video conferencing resources 105 may be designated for a different rate. Therefore, the language interpreters/translators in the voice communication resources 104 remain assigned to the video communication resources 104 even if some or all of those language interpreters/translators have skills that can fulfill a need presented by another set of resources such as the video conferencing resources 105. As a result, the user 102 may have to wait or not obtain a voice language interpretation/translation service if the video conferencing resources 105 are being fully utilized even though language interpreters/translators in the video communication resources 104 that have the requisite skills may be available.

The voice communication resources 104 and the video conferencing resources 105 are illustrated only as examples as a variety of different resources may be utilized to provide language interpretation/translation services. For example, text based resources, machine based resources, in person resources, etc., may be utilized.

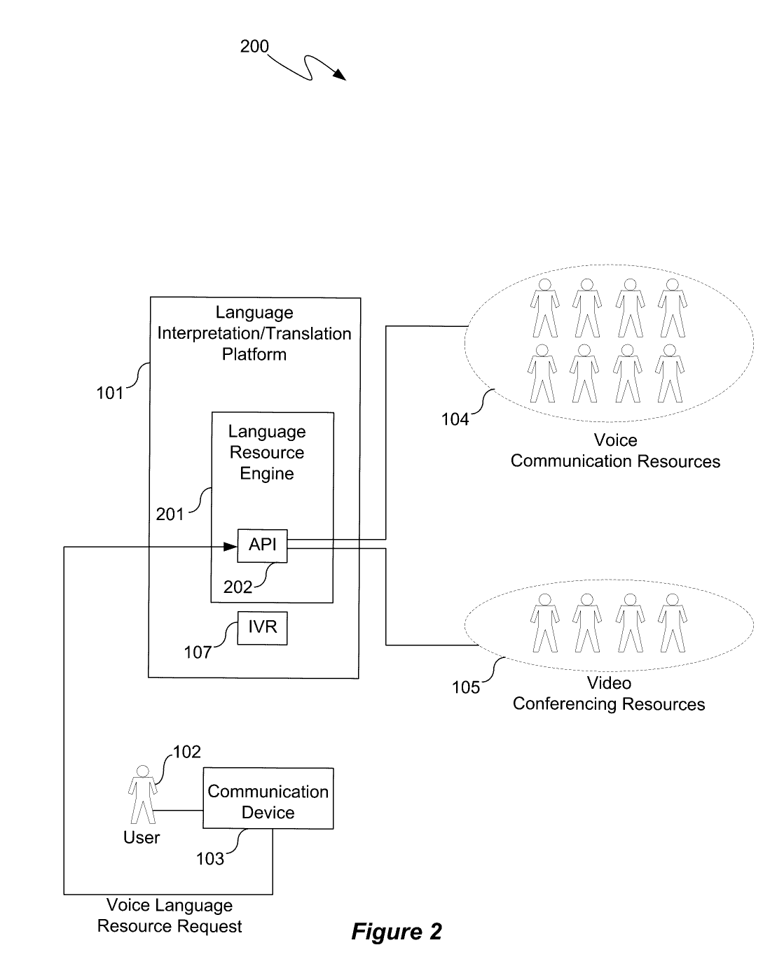

FIG. 2 illustrates a language interpretation/translation resource configuration 200. The language interpretation/translation platform 101 of the language interpretation/translation resource configuration 200 has a language resource engine 201. Further, the language resource engine 201 utilizes an Application Programming Interface (“API”) 202 to allocate and reallocate resources for language interpretation/translation services. The language resource engine 201 also utilizes the API 202 to negotiate the rates of the language interpreters/translators that provide the language interpretation/translation services based upon such allocations and reallocations. In other words, the language resource engine 201 dynamically allocates and reallocates resources for language interpretation/translation services based upon the particular requirements of the user 102 and the availability of the requisite resources.

The API 202 may also be utilized to interact with the communication device 103 associated with the user 102 and to interact with the devices associated with the various resources, e.g., voice communication resources 104, video conferencing resources 105, etc. For example, each of the language interpreters/translators in the various sets of resources may have a corresponding computing device that has an application that may interact with the language resource engine 201 through the API 202. For instance, the language resource engine 201 may send push notifications to language interpreters/translators in the voice communication resources 104 that have the particular language interpretation skills required by the user 102 to determine availability for a temporary reallocation to the video conferencing resources 105. Based upon the various responses received from the available language interpreters/translators, the language resource engine 201 may negotiate an optimal rate for the user 102 and/or language interpretation/translation service provider.

For instance, the user 102 may request language interpretation/translation services for based upon a video conferencing channel of communication. Upon receiving the request, the language resource engine 201 may utilize the API 202 to determine that all of the video conferencing resources 105 are unavailable to respond to the request. The language resource engine 201 may then utilize the API 202 determine if any of the voice communication resources 104 have the capabilities and availability associated with the request of the user, e.g., voice communication language interpretation/translation capabilities based upon the requested scheduling availability of the user 102. For example, the language resource engine 201 may utilize the API 202 to review a database of various resources to determine which resources in a different group of resources other than the video conferencing resources 105 have the capabilities to provide video conferencing language interpretation/translation and then send push notifications or other forms of communication to those resources to determine availability. The language resource engine 201 may then utilize the API 202 to negotiate rates of the capable and available resources, e.g., human language interpreters/translators, machine language interpreters/translators, etc. and reallocate a resource to the video conferencing resources 105 to perform the job for the user 102.

The language resource engine 201 may utilize the API 202 to negotiate a variety of different items. For example, the language resource engine 201 may utilize the API 202 to negotiate service details such as timeliness of service, length of reserved time, completion/delivery timeline, etc. The language resource engine 201 may also utilize the API 202 to allow the user 102 to accept the fee terms and then provide access and/or a direct connection for the user 102 to the language interpretation/translation service.

The API 202 allows the user 102 to bypass the IVR 107. Therefore, the user 102 does not have to provide customer information through the IVR 107. An application stored on the communication device 103 associated with the user 102 may store customer identifying data and other types of data. The communication device 103 may then automatically send such data to the language interpretation/translation platform via the API 202 without the user having to manually provide such data to the IVR 107 or a human operator. The user 102 may utilize the API 202 to request any type of language interpreter/translator based upon language requirements, certification requirements, special knowledge, etc. Further, the user 102 may utilize the API 202 to select various channels, e.g., text, voice, video, in person communication, etc. In addition, the user 102 may utilize the API 202 to select a preferred connection method, e.g., telephone, Session Initiation Protocol (“SIP”), video conferencing, WebRTC, WebSocket, etc.

The language resource engine 201 receives the requests at the API 202 and then allocates or reallocates a resource to perform each request. The language resource engine 201 may also connect the user 201 to that resource. The API 202 is not limited to any particular application or particular channel. Therefore, the API 202 may be integrated into a variety of different applications and may be utilized to select a variety of different channels for a language interpretation/translation request. Thus, the API 202 removes the need for the IVR 107 for language interpreter/translator acquisition for user 102 requests. The user 102 may utilize the API 202 to access a language interpretation/translation resource without having to remember codes or other information that would be required by previous systems that relied on the IVR 107 for such information. In other words, the API 202 may facilitate the gathering and/or transfer of required account and customer data elements that would typically be performed by a human or via the IVR 107. As a result, the API 202 may bypass IVR or human interaction.

Although the IVR 107 is illustrated in FIG. 2, the IVR 107 is not necessary for the implementation of the language interpretation/translation resource configuration 200. The IVR 107 may be utilized for additional services such as answering customer questions, receiving customer comments, etc.

The API 202 in effect may generate a marketplace where language interpreters/translators may register and provide their services to the language community and customers. Businesses and resellers of language interpretation/translation services may utilize the API 202 to access language interpretation/translations services on-demand or to generate a reservation for a subsequent language interpretation/translation interaction.

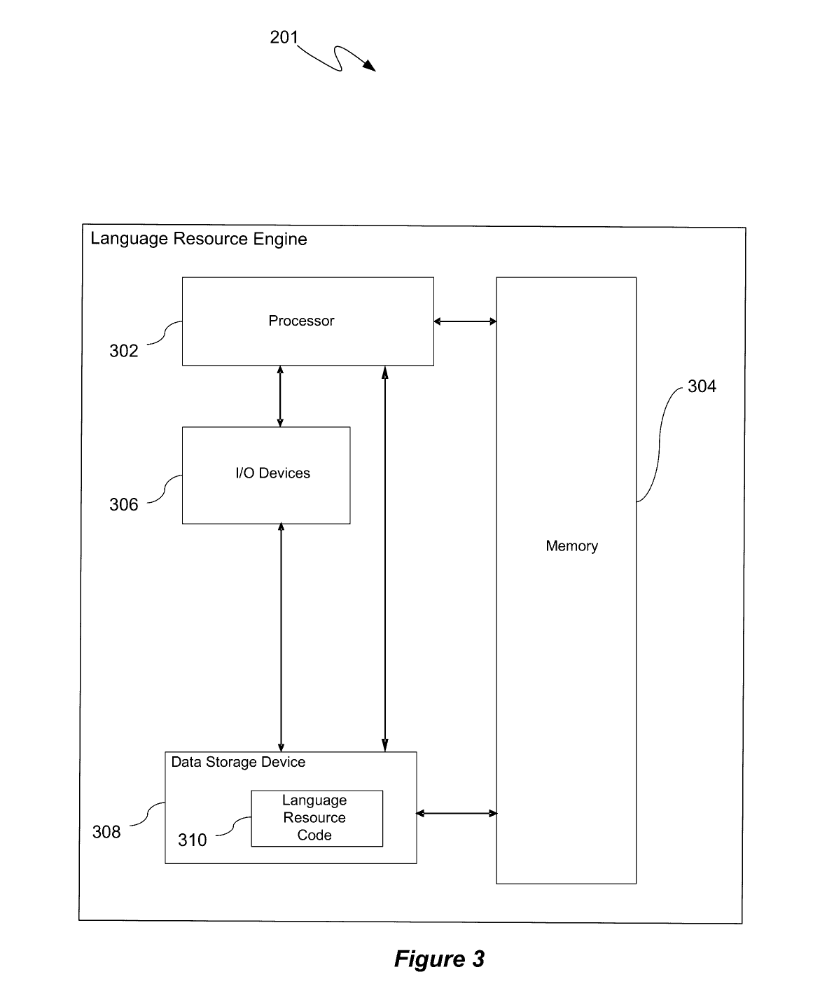

FIG. 3 illustrates the internal components of the language resource engine 201 illustrated in FIG. 2. In one embodiment, the language resource engine 201 is implemented utilizing a general purpose computer or any other hardware equivalents. Thus, the language resource engine 201 comprises a processor 302, a memory 304, e.g., random access memory (“RAM”) and/or read only memory (ROM), various input/output devices 306, e.g., a receiver, a transmitter, a user input device, a speaker, an image capture device, an audio capture device, etc., a data storage device 308, and language resource code 310 stored on the data storage device 308.

The language resource code 310 may be represented by one or more software applications or a combination of software and hardware, e.g., using application specific integrated circuits (“ASIC”), where the software is loaded from a storage device such as a magnetic or optical drive, diskette, or non-volatile memory and operated by the processor 302 in the memory 304 of the computer. As such, the language resource code 310 and associated data structures may be stored on a computer readable medium such as a computer readable storage device, e.g., RAM memory, magnetic or optical drive or diskette, etc. The language resource engine 201 may be utilized for a hardware implementation of any of the configurations provided herein.

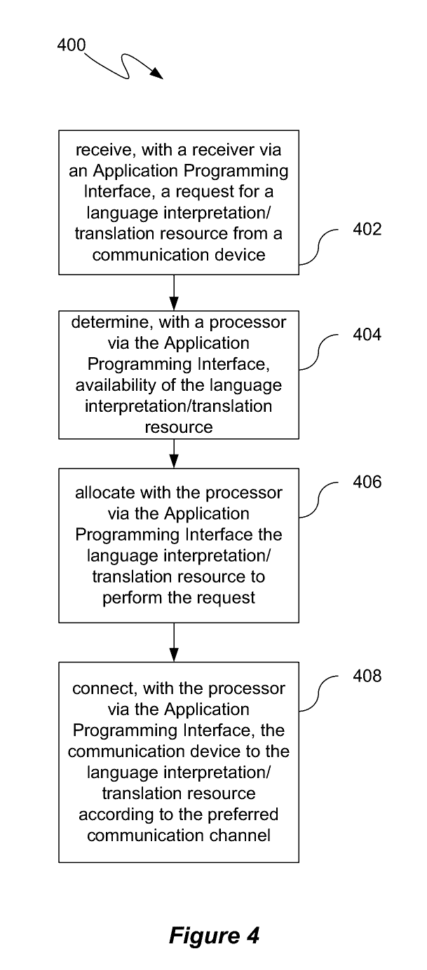

FIG. 4 illustrates a process 400 that may be utilized to perform language interpretation/translation resource allocation. At a process block 402, the process 400 receives, with a receiver via an Application Programming Interface, a request for a language interpretation/translation resource from a communication device. The request includes a preferred communication channel. Further, at a process block 404, the process 400 determines, with a processor via the Application Programming Interface, availability of the language interpretation/translation resource. In addition, at the process block 406, the process 400 allocates with the processor via the Application Programming Interface the language interpretation/translation resource to perform the request. At a process block 408, the process 400 also connects, with the processor via the Application Programming Interface, the communication device to the language interpretation/translation resource according to the preferred communication channel.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium such as a computer readable storage device. The instructions may also be created using source code or any other known computer-aided design tool. A computer readable medium may be any medium capable of storing those instructions and include a CD-ROM, DVD, magnetic or other optical disc, tape, silicon memory, e.g., removable, non-removable, volatile or non-volatile, etc.

A computer is herein intended to include any device that has a general, multi-purpose or single purpose processor as described above. For example, a computer may be a PC, laptop computer, set top box, cell phone, smartphone, tablet device, portable media player, video player, etc.

It is understood that the computer program products, apparatuses, systems, and processes described herein may also be applied in other types of apparatuses, systems, and processes. Those skilled in the art will appreciate that the various adaptations and modifications of the embodiments of the compute program products, apparatuses, systems, and processes described herein may be configured without departing from the scope and spirit of the present computer program products, apparatuses, systems, and processes. Therefore, it is to be understood that, within the scope of the appended claims, the present computer program products, apparatuses, systems, and processes may be practiced other than as specifically described herein.

We claim:

1. A computer implemented language interpretation/translation platform comprising:
a receiver that receives, via an Application Programming Interface, a request for a language interpretation/translation resource from a communication device, the request including a preferred communication channel; and
a processor that determines, via the Application Programming Interface, availability of the language interpretation/translation resource, allocates the language interpretation/translation resource to perform the request, and connects the communication device to the language interpretation/translation resource according to the preferred communication channel.

2. The computer implemented language interpretation/translation platform of claim 1, wherein the preferred communication channel is selected from the group consisting of: voice, text, and video.

3. The computer implemented language interpretation/translation platform of claim 1, wherein the request also includes language interpreter/translator requirements selected from the group consisting of: language skills, language certifications, and special knowledge.

4. The computer implemented language interpretation/translation platform of claim 1, wherein the request also includes a preferred mode of connection selected from the group consisting of: telephone, SIP, WebRTC, and WebSocket.

5. The computer implemented language interpretation/translation platform of claim 1, wherein the processor automatically reallocates, via the Application Programming Interface, the language interpretation/translation resource to perform the request.

6. The computer implemented language interpretation/translation platform of claim 1, wherein the processor automatically reallocates, via the Application Programming Interface, the language interpretation/translation resource to perform the request.

7. The computer implemented language interpretation/translation platform of claim 1, wherein the processor automatically determines, via the Application Programming Interface, the availability of the language interpretation/translation resource by sending a push notification to the language interpretation/translation resource.

8. The computer implemented language interpretation/translation platform of claim 1, wherein the processor automatically generates, via the Application Programming Interface, a reservation for the language interpretation/translation resource to perform the request.

9. The computer implemented language interpretation/translation platform of claim 1, wherein the processor automatically negotiates, via the Application Programming Interface, a rate for the language interpretation/translation resource to perform the request.

10. The computer implemented language interpretation/translation platform of claim 1, wherein the processor automatically performs, via the Application Programming Interface, a registration of the language interpretation/translation resource.

11. The computer implemented language interpretation/translation platform of claim 1, wherein the processor automatically obtains, via the Application Programming Interface, customer identification data from the communication device.

12. The computer implemented language interpretation/translation platform of claim 1, wherein the processor automatically obtains, via the Application Programming Interface, the customer identification data from the communication device without utilization of an Interactive Voice Recognition system.

13. A computer program product comprising a non-transitory computer readable storage device having a computer readable program stored thereon, wherein the computer readable program when executed on a computer causes the computer to:
receive, with a receiver via an Application Programming Interface, a request for a language interpretation/translation resource from a communication device, the request including a preferred communication channel; and
determine, with a processor via the Application Programming Interface, availability of the language interpretation/translation resource;
allocates, with the processor via the Application Programming Interface the language interpretation/translation resource to perform the request; and
connects, with the processor via the Application Programming Interface, the communication device to the language interpretation/translation resource according to the preferred communication channel.

14. The computer program product of claim 13, wherein the preferred communication channel is selected from the group consisting of: voice, text, and video.

15. The computer program product of claim 13, wherein the request also includes language interpreter/translator requirements selected from the group consisting of: language skills, language certifications, and special knowledge.

16. The computer program product of claim 13, wherein the request also includes a preferred mode of connection selected from the group consisting of:
telephone, SIP, WebRTC, and WebSocket.

17. The computer program product of claim 13, wherein the processor automatically reallocates, via the Application Programming Interface, the language interpretation/translation resource to perform the request.

18. The computer program product of claim 13, wherein the processor automatically reallocates, via the Application Programming Interface, the language interpretation/translation resource to perform the request.

19. The computer program product of claim 13, wherein the processor automatically determines, via the Application Programming Interface, the availability of the language interpretation/translation resource by sending a push notification to the language interpretation/translation resource.

20. The computer program product of claim 13, wherein the processor automatically generates, via the Application Programming Interface, a reservation for the language interpretation/translation resource to perform the request.
